(19) United States
(12) Patent Application Publication
(10) Pub. No.: US 2010/0143865 A1
(43) Pub. Date: Jun. 10, 2010

(54) INSTRUMENT FOR REMOVING A SCREW STUMP OF A CONNECTING SCREW OF A TOOTH IMPLANT

(75) Inventors: Silvan Schuermann, Waldenburg (CH); Daniele Mueller, Binningen (CH)

Correspondence Address: RISSMAN HENDRICKS & OLIVERIO, LLP, 100 Cambridge Street, Suite 2101, BOSTON, MA, 02114, US

(73) Assignee: Straumann Holding AG, Basel (CH)

(21) Appl. No.: 12/635,275

(22) Filed: Dec. 10, 2009

(30) Foreign Application Priority Data
Dec. 10, 2008 (CH) CH 1940/08

(51) Int. Cl. A61C 3/00

(52) U.S. Cl. 433/141

(57) ABSTRACT

Instrument for removing a screw stump of a connecting screw of a tooth implant, the instrument including a holding area, a middle area, and a front area with a work area pointing away from the holding area. The work area has a circumferential outer surface and a plurality of thorn-shaped spikes for engagement in an upper end face of the screw stump.

### FIELD OF THE INVENTION

The present invention relates to an instrument for removing a screw stump, in particular for removing a screw stump from a tooth implant.

### BACKGROUND

The use of tooth implants as artificial replacements for tooth roots has in recent years become established practice in the field of dental prosthetics. There are various types of tooth implants, among which the screw-shaped implants have proven useful in particular. Tooth implants made of titanium or of various ceramics are typically used.

Screw-shaped tooth implants are usually composed of an anchoring part, for anchoring the implant in the bone, and of an abutment part, on which a superstructure, for example a crown, is secured. If the anchoring part and the abutment part are designed as a single component, the implant is referred to as a one-piece implant. Alternatively, two-piece implants are also often used in which the anchoring part and the abutment part are designed as two separate components. During implantation, the screw-shaped anchoring part is screwed into a suitable hole drilled in the bone. Later, the superstructure is then secured on the abutment part of the implant.

In two-piece implants, the anchoring part and the abutment part are usually connected to each other with the aid of a connecting screw. For this purpose, the anchoring part and the abutment part each have an inner thread. After the anchoring part has been implanted in the bone of the patient, the abutment part is fitted onto the anchoring part, such that the inner thread of the abutment part lies exactly in the continuation of the inner thread of the anchoring part, and the connecting screw is screwed in. A corresponding tooth implant system is described in EP 1 728 486, for example, where the anchoring part and the abutment part have an inner hexagon and outer hexagon, respectively, in order to avoid rotation between the two implant parts.

When the connecting screw is screwed into the inner thread of anchoring part and abutment part, it can happen in exceptional circumstances that the screw breaks. In this case, the screw stump of the connecting screw that has already been screwed into the implant has to be removed again. This is particularly a problem if the upper end face of the screw stump is relatively smooth and has no projections or depressions. Because of the form fit between the screw stump and the anchoring part/abutment part, it is not possible to remove the screw stump with pincers.

The only possible way of removing the screw stump from the inner thread is to drill the screw stump out. To do so, a hole is drilled into the screw stump along the center axis of the screw stump, the hole being slightly smaller than the diameter of the screw. This procedure is rather difficult, since the anchoring part and/or abutment part can be very easily damaged. If the drilling is not carried out precisely along the center axis of the screw stump, some of the inner thread may be removed; and if the hole is drilled too deeply, the anchoring part is damaged in the continuation of the connecting screw. A lack of precision may thus have a huge impact on the stability of the implant, and it is essential for the drill to be guided very precisely. Moreover, after the drilling has been carried out, the part of the anchoring screw lying outside the drilled hole, that is to say in particular the thread, has to be removed from the anchoring part and abutment part. This procedure on the whole is very awkward and susceptible to errors.

It would be desirable to make available an instrument for removing a screw stump, in particular a screw stump from a tooth implant, which instrument allows the screw stump to be removed from the tooth implant quickly and without any problem and does not damage the surrounding tooth implant.

### SUMMARY OF THE INVENTION

An instrument for removing a screw stump according to one embodiment of the invention comprises a holding area, a front area and a middle area. The instrument also has a centrally arranged longitudinal axis A. The holding area, the middle area, the front area and the work area have a common, centrally arranged longitudinal axis that coincides with the longitudinal axis A of the instrument.

The holding area is used for gripping the instrument. The middle area connects the front area to the holding area. The front area has a substantially circular cylindrical shape and has a work area which points away from the holding area and which has a circumferential outer surface and three to six thorn-shaped spikes. These thorn-shaped spikes are used for engagement in an upper end face of the screw stump that is to be removed. The thorn-shaped spikes of the work area are distributed uniformly in the circumferential direction about the longitudinal axis of the instrument.

The instrument according to one embodiment of the invention can be used to remove a screw stump that has been screwed at least partially into a tooth implant. For this purpose, the instrument has thorn-shaped spikes for engagement in an upper end face of the screw stump. By pressing the thorn-shaped spikes of the instrument against the upper end face of the screw stump and at the same time applying a torque to the instrument, the screw stump can be turned out of the implant. The thorn-shaped spikes are not rammed into the upper end face, and instead the torque is transferred by virtue of friction on the surface of the screw stump. In this way, the load placed on the tooth implant and also on the surrounding bone tissue is kept as low as possible and does not cause damage.

The front area of substantially circular cylindrical shape is designed in such a way that it can be inserted without problem into the inner thread in the anchoring part and abutment part of the implant. The diameter of the front area is preferably only slightly smaller than that of the inner thread, such that the instrument is guided by the inner walls of the implant parts during removal of the screw stump.

In a preferred embodiment, the tips of the thorn-shaped spikes lie on the circumferential outer surface of the work area. This arrangement of the spikes optimizes the torque transfer from the instrument to the screw stump. Moreover, the production of the front area, which is preferably done by grinding a substantially cylindrical pin, is much easier than in the case of spikes whose tips lie further to the inside. In an arrangement of this kind, the spikes are also particularly strong.

Alternatively, the tips of the thorn-shaped spikes can lie further to the inside.

In a preferred embodiment, the holding area and/or the middle area have a substantially circular cylindrical shape. This configuration permits simple machine production of the instrument. Moreover, in this embodiment, the middle area of the instrument can serve as a guide area, said middle area being guided by the substantially circular cylindrical inner faces of the anchoring part and abutment part of the implant. This makes handling of the instrument much easier.

In another preferred embodiment, the work area of the instrument has four thorn-shaped spikes. This arrangement permits optimal transfer of a torque to the screw stump in order to remove the latter.

Each individual spike of the work area preferably has substantially three surfaces that meet at the tip of the spike:

(i) a first, curved surface that coincides with the circumferential outer surface of the work area,

(ii) a second, plane surface that lies parallel to the longitudinal axis A of the instrument, and

(iii) a third, plane surface that is inclined by an angle a with respect to the longitudinal axis.

In contrast to the first circumferential surface, the second and third surfaces, referred to as “plane”, are not curved. The term “plane” is used in this sense here and in the further course of this application document. This spike shape permits particularly good transfer of torque from the instrument to the screw stump. Moreover, the production of the front area, which is preferably done by grinding a substantially circular cylindrical pin, is much easier than with other spike shapes. The spikes also have particularly good stability.

The second surface, lying parallel to the longitudinal axis A, of one spike preferably lies in front of the third, inclined surface of the same spike, as seen in the counterclockwise direction. To define the clockwise direction, it is assumed here, and in the rest of the text below, that the instrument is being viewed from the direction of the tips of the thorn-shaped spikes and that clockwise and counterclockwise are defined accordingly. The second surface of a spike, lying parallel to the longitudinal axis A, thus lies in front of the third, inclined face of the same spike, as seen in the counterclockwise direction, if one proceeds in the counterclockwise direction from the second surface to the third surface of the same spike.

The second surface, lying parallel to the longitudinal axis A, and the inclined third surface are preferably arranged in such a way that the surface lying parallel to the longitudinal axis A is in a lead position during removal of the screw stump. Therefore, if the instrument has to be turned in the counterclockwise direction in order to remove the screw stump, as is the case in the threads customarily used today, the second surface, lying parallel to the longitudinal axis A, then lies preferably in front of the third, inclined surface on the same axis. This arrangement optimizes the transfer of the torque to the screw stump, such that the least possible force has to be applied, and the load placed on the implant and on the surrounding bone tissue can be kept as low as possible.

The third, inclined surface is preferably inclined by an angle α of 30-60°, preferably of 45°, with respect to the longitudinal axis A of the instrument.

In another preferred embodiment, each individual spike of the instrument has substantially three surfaces that meet at the tip:

(i) a first, curved surface that coincides with the circumferential outer surface of the work area,

(ii) a second, plane surface that is inclined by an angle β with respect to the longitudinal axis A, and

(iii) a third, plane surface that is inclined by an angle γ with respect to the longitudinal axis.

The two angles β and γ are preferably 10-45°, particularly preferably 20-30°, independently of each other.

In another preferred embodiment, each individual spike of the work area has substantially three surfaces that meet at the tip:

i) a first, curved surface that coincides with the circumferential outer surface of the work area,

(ii) a second, inwardly curved surface that is inclined by an angle δ with respect to the longitudinal axis A, and

(iii) a third, inwardly curved surface that is inclined by an angle ε with respect to the longitudinal axis.

The two angles δ and ε are preferably 10-45°, particularly preferably 20-30°, independently of each other.

In a preferred embodiment, the holding area of the instrument is designed such that a torque can be transferred to the instrument by hand. This allows the screw stump to be easily turned out without great effort and without a further tool being needed.

Alternatively, the holding area of the instrument designed such that a torque can be transferred to the instrument by a ratchet wrench. In this way, greater torques can be transferred to the instrument and therefore to the screw stump.

In a preferred embodiment, the material and shape of the instrument are chosen such that the instrument can be sterilized after use and can subsequently be used again to remove a screw stump, in particular from a tooth implant. As regards its shape, care must be taken in this embodiment to ensure that the instrument has no undercuts or any other areas that are difficult to access by sterilization. Alternatively, the instrument can be designed to be used just once.

In a preferred embodiment, at least the work area of the instrument is made of a strong, easily sterilizable material, in particular of a metal. It is particularly preferable for at least the work area to be made of stainless steel, for example Cronidur®. It is preferable for not just the work area, but instead the entire instrument to be made of such a material, in particular of stainless steel. This makes the production, cleaning and sterilizing of the instrument much easier.

The present invention further relates to the use of an instrument for removing a screw stump, in particular for removing a screw stump from a tooth implant. As has been described above, the use of the instrument is of particular advantage when the upper end face of the screw stump is very smooth. In this case, the screw stump can be removed from the implant with the aid of the instrument without damaging the implant and the surrounding bone tissue.

### BRIEF DESCRIPTION OF THE DRAWINGS

FIG. 1 is a side view of an instrument according to one embodiment of the invention;

FIG. 2 is an enlarged side view of the front area and middle area of the instrument of FIG. 1;

FIG. 3 is an enlarged oblique plan view of the front area and middle area of the instrument of FIG. 1;

FIG. 4 is an enlarged oblique plan view of the front area of the instrument of FIG. 1; and

FIG. 5 is a schematic cross sectional view showing use of the instrument of FIG. 1 for removing a screw stump from a tooth implant.

### DETAILED DESCRIPTION

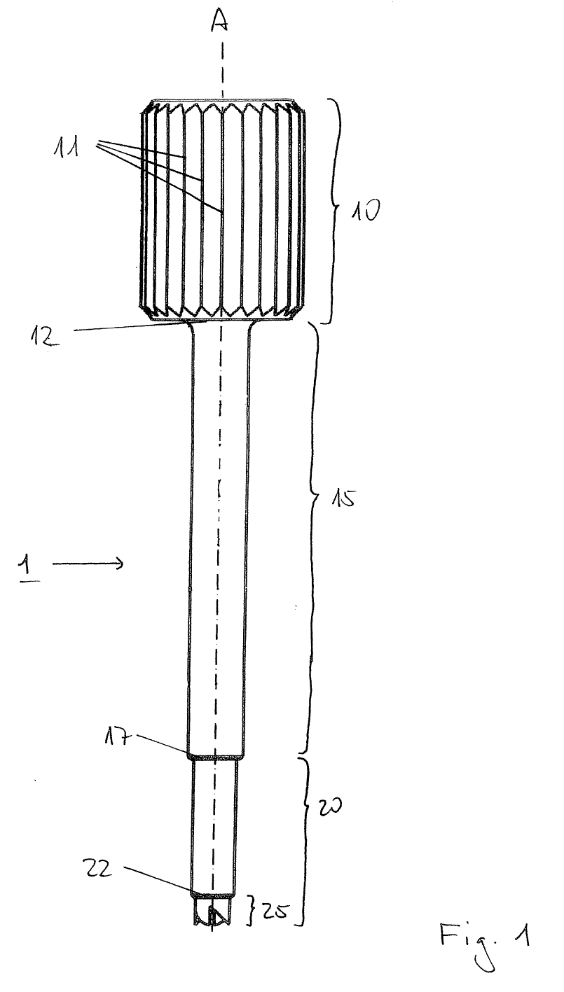

FIG. 1 shows an instrument 1 according to one embodiment of the invention for removing a screw stump. The depicted instrument 1 is made of stainless steel and comprises a holding area 10, a middle area 15, and a front area 20, and it has a centrally arranged longitudinal axis A. The front area 20 has a work area pointing away from the holding area 10. In the embodiment shown, the holding area 10, the middle area 15 and the front area 20 have a substantially circular cylindrical shape, the diameter decreasing in each case from the holding area 10 to the middle area 15 to the front area 20. The diameter of the middle area is chosen such that the middle area is guided by the implant upon removal of the screw stump. The dimensions of the front area are likewise adapted to the sizes of the screw stump and of the anchoring part and abutment part. Arranged between the holding area 10 and the middle area 15 is a first transition area 12, of which the diameter merges from that of the holding area 10 into that of the middle area 15. Arranged between the middle area 15 and the front area 20 is a second transition area 17, of which the diameter merges from that of the middle area 15 into that of the front area 20. Finally, the depicted instrument 1 has a third transition area 22, which adjoins the work area 25.

The holding area 10 has a plurality of lamella-shaped projections 11 that extend parallel to the longitudinal axis A of the instrument 1 and that are designed to make it easier to grip the instrument 1 and prevent its slipping. These lamella-like projections 11 do not have any undercuts, with the result that the instrument 1 can be easily sterilized. They are also designed such that a suitable tool can interact with the projections 11.

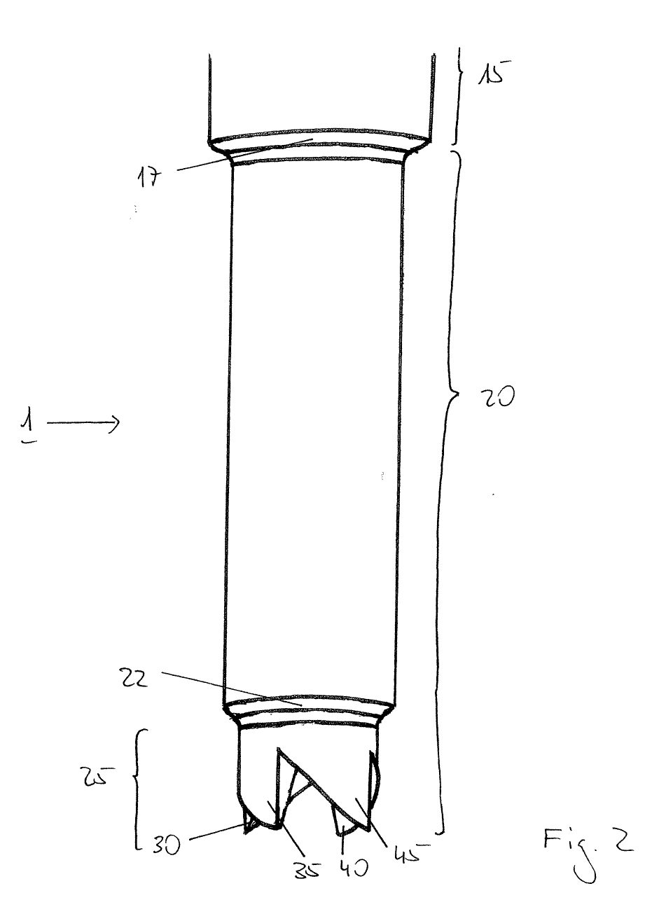

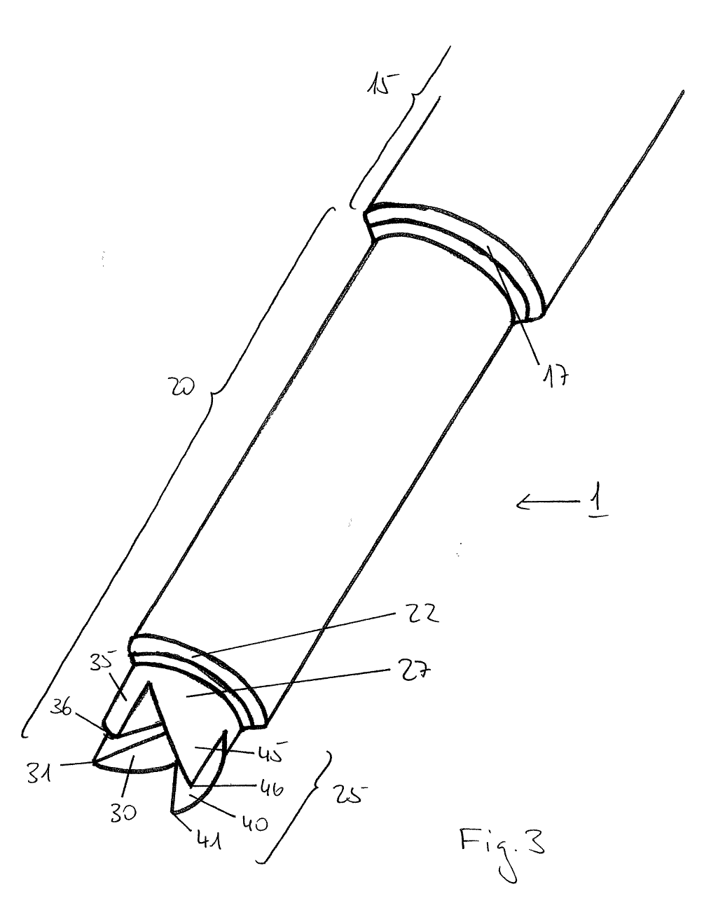

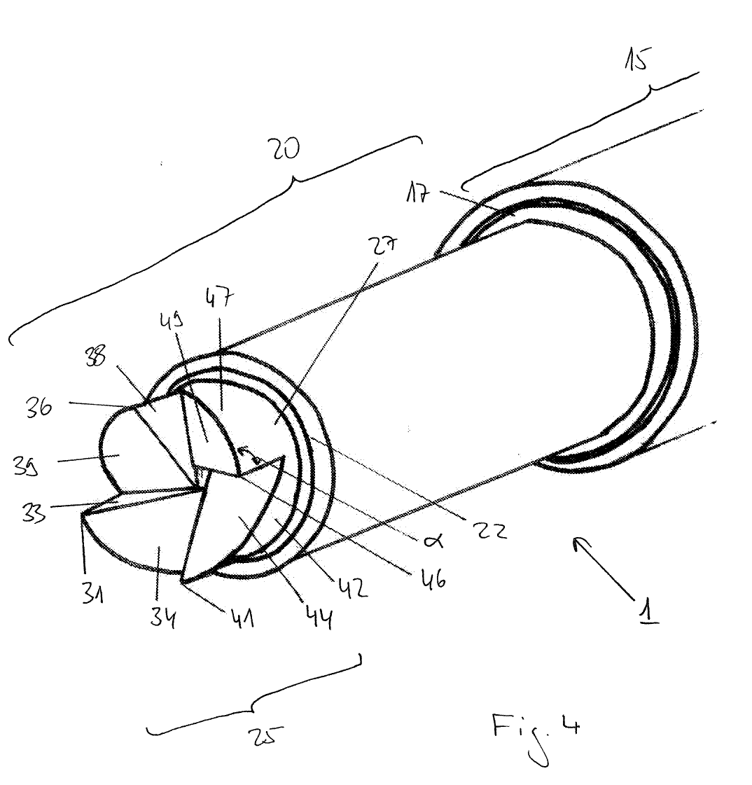

FIGS. 2 to 4 show enlarged side views and oblique plan views of the middle area 15, the front area 20 and the work area 25 of the instrument 1. The work area 25 shown in FIGS. 1 to 5 has four thorn-shaped spikes 30, 35, 40 and 45, which are distributed uniformly in the circumferential direction about the longitudinal axis A (FIG. 2). The tips 31, 36, 41 and 46 of the four thorn-shaped spikes 30, 35, 40, 45 lie on the circumferential outer surface 27 of the work area 25 (FIG. 3). Each of the four thorn-shaped spikes 30, 35, 40 and 45 has substantially three surfaces that meet at the tip 31, 36, 41 or 46 (FIG. 4): a first, curved surface 42, 47 coincides with the circumferential outer surface 27 of the work area 25; a second, plane surface 33, 38 lies parallel to the longitudinal axis A of the instrument 1, and a third, plane surface 34, 39, 44, 49 is inclined by an angle a with respect to the longitudinal axis A.

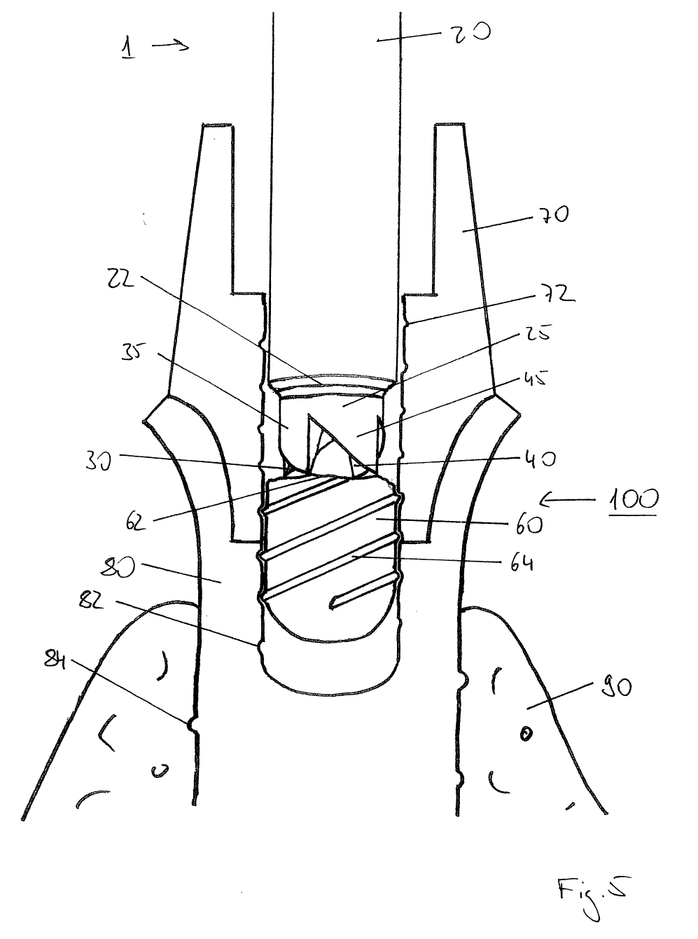

FIG. 5 shows a schematic cross section through a tooth implant 100 that has been inserted into a jaw bone 90. The tooth implant 100 comprises an anchoring part 80 and an abutment part 70, which is fitted onto the anchoring part 80. The anchoring part 80 has an outer thread 84 for anchoring the tooth implant 100 in the jaw bone 90. The abutment part 70 and the anchoring part 80 both have a respective inner thread 72, 82, the inner thread 72 of the abutment part 70 lying exactly in the axial continuation of the inner thread 82 of the anchoring part. A screw stump 60, that is to say a broken-off part of a connecting screw, sits in the inner threads 72, 82. The screw stump 60 has an outer thread 64 for anchoring in the inner threads 72, 82 of the tooth implant 100. At its coronal end, the screw stump 60 has a substantially straight upper end face 62. The instrument 1, of which the front area 20, the third transition area 22 and the work area 25 with its four thorn-shaped spikes 30, 35, 40, 45 can be seen in the figure, is used to remove the screw stump 60 from the inner threads 72, 82. For this purpose, the four thorn-shaped spikes 30, 35, 40, 45 of the work area 25 are pressed against the upper end face 62 of the screw stump 60. By turning the instrument 1, a torque can be transferred to the screw stump 60 and the latter can thus be removed from the tooth implant 100.

1. An instrument for removing a screw stump of a connecting screw of a tooth implant, the instrument comprising:
(a) a holding area for gripping the instrument,
(b) a substantially circular cylindrical front area with a work area that points away from the holding area and that has a circumferential outer surface and three to six thorn-shaped spikes for engagement in an upper end face of the screw stump, and
(c) a middle area that connects the front area to the holding area,
the instrument having a centrally arranged longitudinal axis A, and
the holding area, the middle area, the front area and the work area having a common, centrally arranged longitudinal axis that coincides with the longitudinal axis A of the instrument,
wherein
the thorn-shaped spikes of the work area are distributed uniformly in the circumferential direction about the longitudinal axis.

2. The instrument as claimed in claim 1, wherein each of the thorn-shaped spikes has a tip that lies on the circumferential outer surface of the work area.

3. The instrument as claimed in claim 1, wherein oen or both of the holding area and the middle area has a substantially circular cylindrical shape.

4. The instrument as claimed in claim 1, wherein the work area has four thorn-shaped spikes.

5. The instrument as claimed in claim 1, wherein each individual spike has substantially three surfaces that meet at a tip, of which a first, curved surface coincides with a circumferential outer surface of the work area, a second, plane surface lies parallel to the longitudinal axis A of the instrument, and a third, plane surface is inclined by an angle a with respect to the longitudinal axis A.

6. The instrument as claimed in claim 5, wherein the second surface, lying parallel to the longitudinal axis A, of a spike lies in front of the third, inclined surface of the same spike in the counterclockwise direction.

7. The instrument as claimed in claim 5, wherein the angle α is 30 to 60°.

8. The instrument as claimed in claim 5, wherein the angle α is 45°.

9. The instrument as claimed in claim 1, wherein each individual spike has substantially three surfaces that meet at a tip, of which a first, curved surface coincides with a circumferential outer surface of the work area, a second, plane surface is inclined by an angle β with respect to the longitudinal axis A, and a third, plane surface is inclined by an angle γ with respect to the longitudinal axis A.

10. The instrument as claimed in claim 1, wherein each individual spike has substantially three surfaces that meet at a tip, of which a first, curved surface coincides with a circumferential outer surface of the work area, a second, inwardly curved surface is inclined by an angle δ with respect to the longitudinal axis A, and a third, inwardly curved surface is inclined by an angle ε with respect to the longitudinal axis A.

11. The instrument as claimed in claim 1, wherein the holding area is designed such that a torque can be transferred to the instrument by hand.

12. The instrument as claimed in claim 1, wherein the holding area is designed such that a torque can be transferred to the instrument by a ratchet wrench.

13. The instrument as claimed in claim 1, wherein at least the work area is made of stainless steel.

14. The instrument as claimed in claim 12, wherein the entire instrument is made of stainless steel.

15. A method comprising use of an instrument as claimed in claim 1 for removing a screw stump of a connecting screw of a tooth implant

16. The method as claimed in claim 15, including engaging the thorn-shaped spikes in an upper end face of the screw stump.

17. The method as claimed in claim 15, including pressing the thorn-shaped spikes in an upper end face of the screw stump and at the same time applying a torque to the instrument such that the screw stump is turned out of the implant.

18. The method as claimed in claim 15, wherein the front area has a diameter slightly smaller than inner walls on each of an anchoring part and an abutment part of the implant, and wherein the front area is guided by the inner walls into the abutment part and anchoring part of the implant.

19. The method as claimed in claim 18, wherein the middle area has a diameter slightly smaller than inner walls on each of an anchoring part and an abutment part of the implant, and wherein the middle area is guided by the inner walls into the abutment part and anchoring part of the implant.
